(19) United States
(12) Patent Application Publication
(10) Pub. No.: US 2014/0104545 A1
(43) Pub. Date: Apr. 17, 2014

(54) DISPLAY DEVICE

(71) Applicants: Miyuki Sugita, (US); Japan Display Inc., Tokyo (JP)

(72) Inventors: Toshio MIYAZAWA, Tokyo (JP); Terunori SAITOU, Tokyo (JP); Tatsuya SUGITA, Tokyo (JP); Shinichiro OKA, Tokyo (JP)

(73) Assignee: Japan Display Inc., Tokyo (JP)

(21) Appl. No.: 14/050,538

(22) Filed: Oct. 10, 2013

(30) Foreign Application Priority Data
Oct. 15, 2012 (JP) 2012-227950

(51) Int. Cl. G02F 1/1343

(52) U.S. Cl. CPC G02F 1/134309
USPC 349/96

(57) ABSTRACT

A display device includes an display panel, a liquid crystal lens panel disposed on the display panel, and adapted to form a lenticular lens by switching, and a polarization plate disposed on an opposite side of the liquid crystal lens panel to the display panel, the liquid crystal lens panel includes a liquid crystal layer, a first insulating substrate disposed on the display panel side of the liquid crystal layer, a second insulating substrate disposed on the polarization plate side, and having an oriented film with a rubbing direction perpendicular to a rubbing direction of an oriented film of the first insulating substrate, and a plurality of strip electrodes extending in one direction, arranged side by side on the first insulating substrate, wherein a polarization axis direction of the polarization plate is the same as the rubbing direction of the second oriented film.

### CROSS-REFERENCE TO RELATED APPLICATION

The present application claims priority from Japanese application JP2012-227950 filed on Oct. 15, 2012, the content of which is hereby incorporated by reference into this application.

### BACKGROUND OF THE INVENTION

1. Field of the Invention

The present invention relates to a display device, and in particular to a 3D display device using a lenticular system.

2. Description of the Related Art

As one of the display systems for 3D images not using a pair of glasses, there have been known a lenticular system and a parallax barrier system. The parallax barrier system is a system in which an image obtained by cutting an image of a visual field of the right eye and an image of a visual field of the left eye vertically to form strips of the images and then arranging the strips of the images alternately is disposed behind a plate provided with a plurality of thin vertical slits called parallax barrier, and by observing the image through the parallax barrier disposed in front of the image, images different from each other are provided respectively to the right eye and the left eye, and thus a 3D image is displayed.

On the other hand, the lenticular system is a system in which an object called lenticular lens obtained by laterally arranging semicylindrical lenses each extending longitudinal is disposed instead of the parallax barrier, and by observing the image through the lenticular lens, the images different from each other are provided respectively to the right eye and the left eye, and thus a 3D image is displayed.

JP 2009-520231 T describes an example of realizing the lenticular lens using a liquid crystal lens to thereby display a 3D image.

### SUMMARY OF THE INVENTION

FIGS. 13 and 14 are diagrams showing a 3D image display panel 600 for explaining the principle of a liquid crystal lens 610. As shown in FIGS. 13 and 14, the liquid crystal lens 610 is disposed on a display surface of a display device 620 such as a liquid crystal display device. The liquid crystal lens 610 includes two glass substrates 611 and 615, a liquid crystal layer 613 formed of a liquid crystal compositions encapsulated between these glass substrates, a sheet electrode 612, which is a transparent electrode formed on the glass substrate 611 on the opposite side of the liquid crystal layer 613 to the display device 620 side evenly throughout the entire screen, and strip electrodes 614, which are transparent electrodes formed on the glass substrate 615 on the display device 620 side to have a strip shape and arranged so as to correspond to every two pixels of the display device.

FIG. 13 shows the state of the orientation of the liquid crystal compositions in the liquid crystal lens 610 when performing 2D display, wherein the sheet electrode 612 and the strip electrodes 614 have the same electrical potential, and the orientation directions of the liquid crystal compositions are the same (homogeneous alignment) throughout the entire liquid crystal layer 613. By making the direction coincide with the polarization direction of the light emitted from the display device 620, the light emitted from the display device 620 passes through the liquid crystal lens 610 with the polarization direction maintained, and thus the 2D image displayed on the display device 620 can directly be observed. In other words, the lights emitted from pixels 631 and 632 of the display device 620 are observed with the both eyes, respectively.

FIG. 14 is a diagram showing the state of the orientation of the liquid crystal compositions in the liquid crystal lens 610 when performing the 3D display, wherein voltages different from each other are applied respectively to the sheet electrode 612 and each of the strip electrodes 614 while changing the polarity at an inversion drive period. As shown in this drawing, due to the difference in shape between the sheet electrode 612 and the strip electrode 614, a two-dimensionally radial and three-dimensionally cylindrical electrical field is generated in the liquid crystal layer, and the lenticular lens is formed by the liquid crystal compositions aligning along the electrical field, which makes the 3D display possible. Specifically, as shown in the drawing, the light emitted from the pixel 631 is observed by the right eye, and the light emitted from the pixel 632 is observed by the left eye.

Here, when performing the 3D display, the phenomenon that the right-eye image enters the left eye, or the left-eye image enters the right eye is called crosstalk, and the higher the proportion of the crosstalk is, the more the display quality of the 3D display is degraded. According to a study by the inventors, it has been found out that the light passing through the strip electrodes 614 such as the light indicated by L1 and L3 or the light indicated by L2 and L4 in the configuration shown in FIG. 14 causes major crosstalk. The liquid crystal compositions above the strip electrodes 614 hardly have the lens effect since the long axis direction of the liquid crystal compositions is oriented in the thickness direction of the liquid crystal layer 613 due to the electrical field between the sheet electrode 612 and the strip electrodes 614, and the light passing through this part is not affected by the direction control by the lens. Therefore, the light passing through this part is emitted in all directions, and becomes a major factor of the crosstalk.

In view of the circumstances described above, an object of the invention is to provide a display device reduced in crosstalk in the display device capable of performing the 3D display using the liquid crystal lens.

A display device according to an aspect of the invention includes a display panel having a plurality of pixels arranged in a matrix, and adapted to display an image, a liquid crystal lens panel disposed on the display panel, and adapted to form a lenticular lens by switching, and a polarization plate disposed on an opposite side of the liquid crystal lens panel to the display panel, the liquid crystal lens panel includes a liquid crystal layer having liquid crystal compositions, a first insulating substrate disposed on the display panel side of the liquid crystal layer, a second insulating substrate disposed on the polarization plate side of the liquid crystal layer, and having an oriented film with a rubbing direction perpendicular to a rubbing direction of an oriented film of the first insulating substrate, and a plurality of strip electrodes each formed of a strip-shaped electrically-conductive film extending in one direction, arranged side by side on either one of the first insulating substrate and the second insulating substrate, wherein a polarization axis direction of the polarization plate is the same as the rubbing direction of the oriented film of the second insulating substrate.

Further, in the display device according to the aspect of the invention, it is possible that a sheet electrode, which is an electrically-conductive film formed evenly throughout an entire display area on the other of the first insulating substrate and the second insulating substrate, is further included.

Further, in the display device according to the aspect of the invention, it is possible that the strip electrodes correspond to first strip electrodes formed on the first insulating substrate, and a plurality of second strip electrodes each formed of a strip-shaped electrically-conductive film extending in a direction perpendicular to the one direction, arranged side by side on the second insulating substrate is further included.

Further, in the display device according to the aspect of the invention, it is possible that the strip electrodes adjacent to each other are arranged side by side with an interval corresponding to two pixels.

### BRIEF DESCRIPTION OF THE DRAWINGS

FIG. 1 is a diagram schematically showing a 3D display device according to a first embodiment of the invention.

FIG. 2 is a diagram showing a configuration of a liquid crystal module shown in FIG. 1.

FIG. 3 is a plan view for explaining an arrangement of electrodes of a liquid crystal lens panel shown in FIG. 2.

FIG. 4 is a diagram showing a cross-section along the IV-IV line shown in FIG. 3.

FIG. 5 is a diagram schematically showing traveling directions of light in the case of applying respective electrical potentials different from each other (an alternating-current voltage) to a sheet electrode and each of strip electrodes.

FIG. 6 is a plan view for explaining an arrangement of electrodes of a liquid crystal lens panel capable of performing vertical display and horizontal display in a switching manner.

FIG. 7 is a diagram showing a cross-section along the VII-VII line shown in FIG. 6.

FIG. 8 is a diagram schematically showing the state of the orientation of the liquid crystal compositions in the case of performing 3D display as the horizontal display in the same cross-section as in FIG. 7.

FIG. 9 is a timing chart of an alternating-current voltage applied to each of strip electrodes and each of plate electrodes in the case of FIG. 8.

FIG. 10 is a diagram showing a cross-section along the X-X line shown in FIG. 6.

FIG. 11 is a diagram schematically showing the state of the orientation of the liquid crystal compositions in the case of performing the 3D display as the vertical display in the same cross-section as in FIG. 10.

FIG. 12 is a timing chart of an alternating-current voltage applied to each of strip electrodes and each of plate electrodes in the case of FIG. 11.

FIG. 13 is a diagram showing the state of the orientation of the liquid crystal compositions of the liquid crystal lens when performing 2D display.

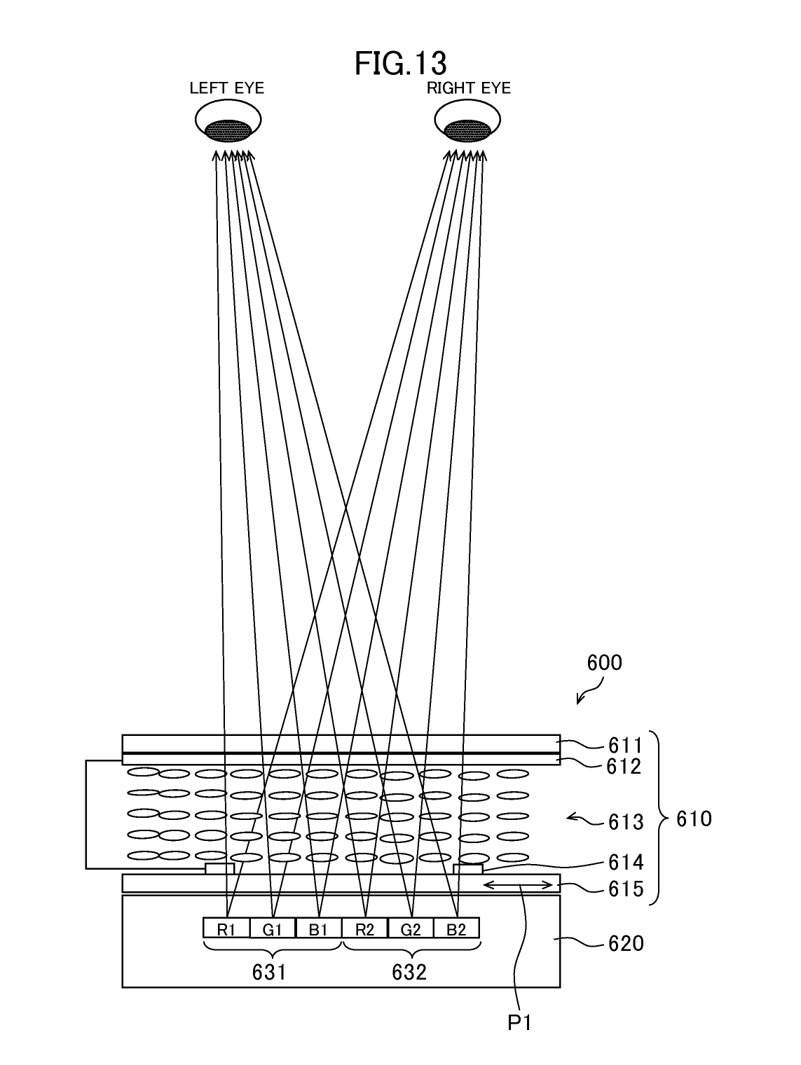

FIG. 14 is a diagram showing the state of the orientation of the liquid crystal compositions of the liquid crystal lens when performing the 3D display.

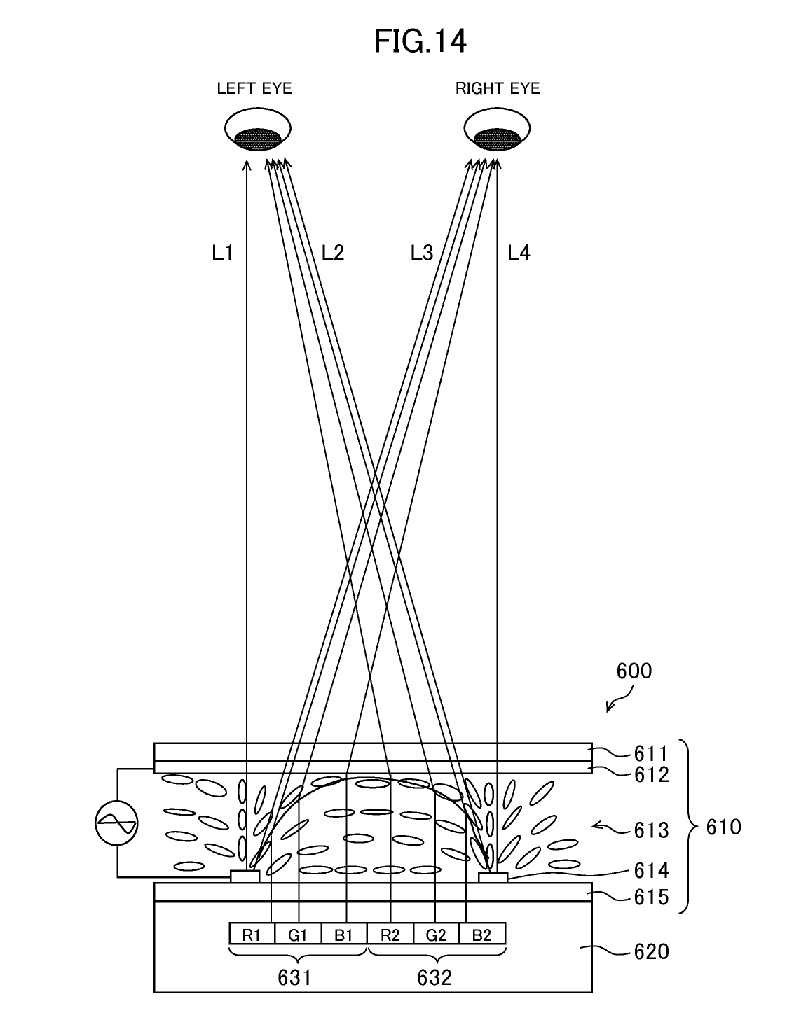

### DETAILED DESCRIPTION OF THE INVENTION

Hereinafter, a first embodiment and a second embodiment of the invention will be explained with reference to the accompanying drawings. It should be noted that in the drawings, the same or equivalent elements will be denoted with the same reference symbols, and redundant explanations will be omitted.

### First Embodiment

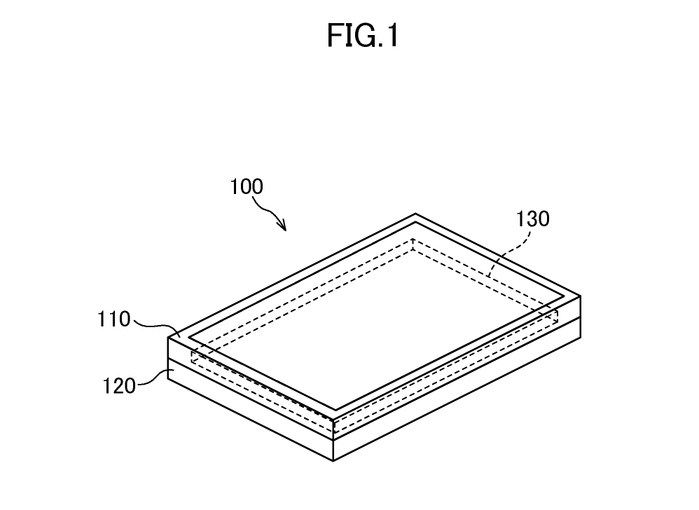

FIG. 1 schematically shows a 3D display device 100 according to a first embodiment of the invention. As shown in the drawing, the 3D display device 100 is composed of a liquid crystal module 130 fixed so as to be sandwiched between an upper frame 110 and a lower frame 120, a power supply device not shown, and so on.

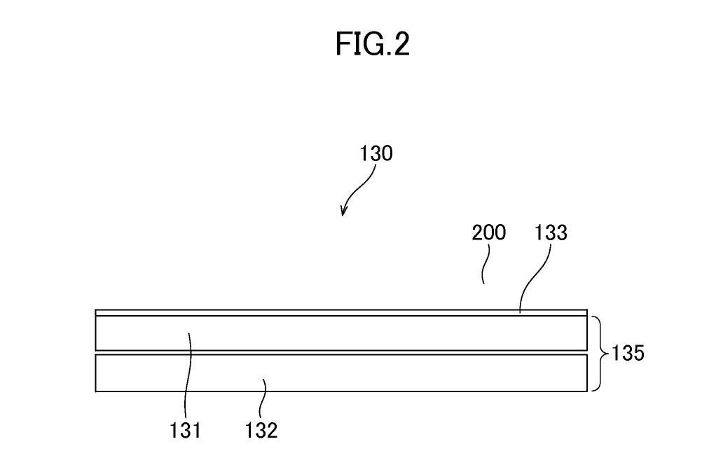

FIG. 2 shows a configuration of the liquid crystal module 130. The liquid crystal module 130 is composed of a liquid crystal display panel 131, which is a display panel for transmitting the light corresponding to an image of a video signal in response to input of the video signal to thereby display a 2D image, a backlight unit 132 for emitting the light to be transmitted through the liquid crystal display panel 131, and a liquid crystal lens panel 200 capable of functioning as lenses by controlling the orientation of internal liquid crystal compositions in order to generate parallax in the image displayed by the light transmitted through the liquid crystal display panel 131, wherein the liquid crystal panel 131 and the backlight unit 132 constitute a liquid crystal display device 135 for performing ordinary 2D display, and the liquid crystal display panel 131 and the liquid crystal lens panel 200 are bonded to each other with a bonding layer 133.

It should be noted that although it is assumed in the present embodiment that the liquid crystal display device 135 is used as the display device, it is also possible to adopt a display device of a system not using the liquid crystal such as an organic EL display device or a field emission display device (FED).

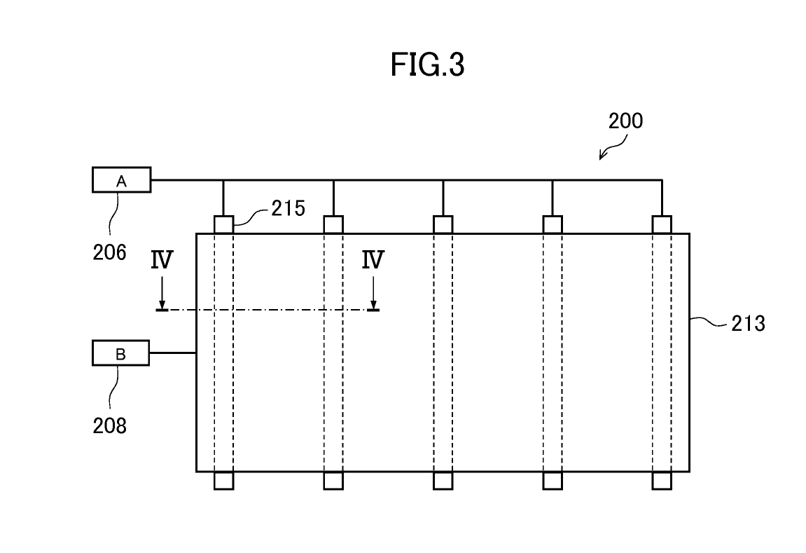

FIG. 3 is a plan view for explaining an arrangement of electrodes of the liquid crystal lens panel 200 shown in FIG. 2. As shown in this drawing, the liquid crystal lens panel 200 includes a sheet electrode 213 as an electrically-conductive pattern extending in the entire display area, strip electrodes 215 as a plurality of strip-shaped electrically-conductive patterns, a terminal 208 for applying an electrical potential to the sheet electrode 213, and a terminal 206 for applying an electrical potential to the strip electrodes 215.

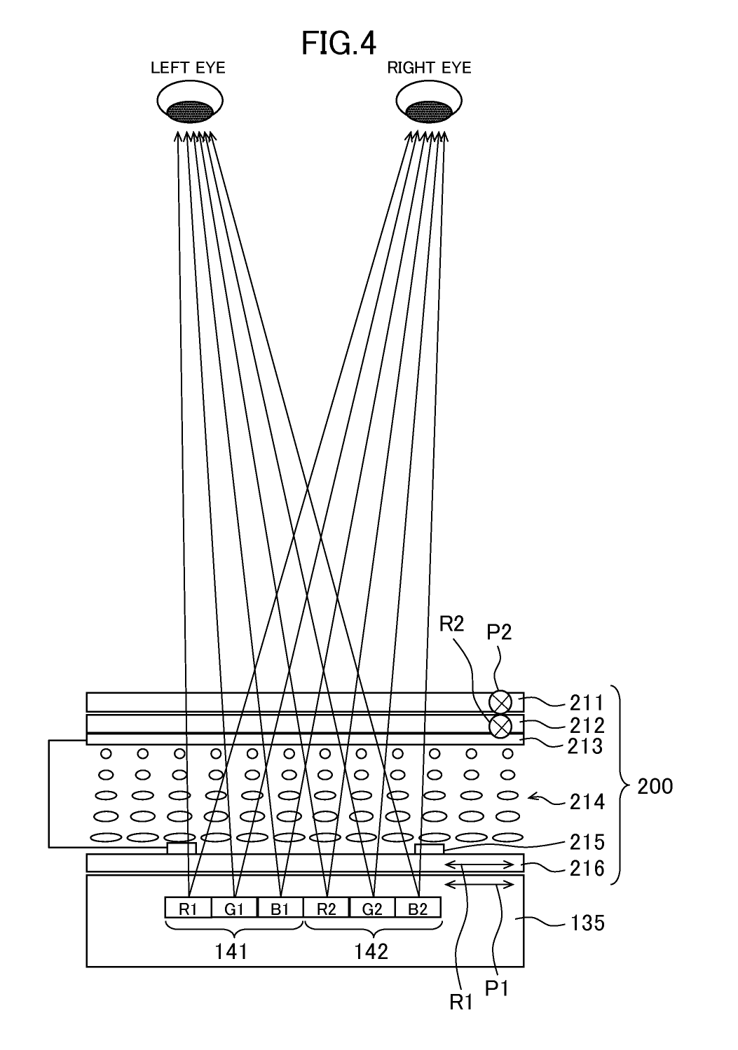

FIG. 4 is a diagram showing a cross-section along the IV-IV line shown in FIG. 3. As shown in this drawing, the liquid crystal lens panel 200 includes a liquid crystal layer 214 formed of the liquid crystal compositions varying the orientation in accordance with the electrical field, a glass substrate 216 as an insulating substrate disposed on the liquid crystal display device 135 side of the liquid crystal layer 214, and provided with the strip electrodes 215, a glass substrate 212 as an insulating substrate disposed on the opposite side of the liquid crystal layer 214 to the liquid crystal display device 135 side, and provided with the sheet electrode 213, and a polarization plate 211 disposed on the opposite side of the glass substrate 212 to the liquid crystal display device 135 side.

Here, in the liquid crystal display device 135 shown in the drawing, there are shown pixels 141 and 142 adjacent to each other and each formed of three colors of R (red), G (green), and B (blue), and the strip electrodes 215 are disposed with an interval corresponding to two pixels. It should be noted that the strip electrodes 215 and the sheet electrode 213 can also be disposed on the glass substrate 212 and the glass substrate 216, respectively, namely the glass substrate on the opposite side.

Here, P1 indicates a polarization direction of the light emitted from the liquid crystal display device 135, namely a polarization direction of an upper polarization plate of the liquid crystal display device 135, and R1 represents a rubbing direction of an oriented film formed on the glass substrate 216. As shown in the drawing, the polarization direction P1 and the rubbing direction R1 coincide with each other.

Further, P2 indicates a polarization direction of the polarization plate 211, and R2 represents a rubbing direction of an oriented film formed on the glass substrate 212. The polarization direction P2 and the rubbing direction R2 coincide with each other, and the direction thereof is perpendicular to the direction of the polarization direction P1 and the rubbing direction R1. In FIG. 4, the same electrical potential is applied to the sheet electrode 213 and the strip electrodes 215 via the terminals 206 and 208, and the liquid crystal compositions in the liquid crystal layer 214 are aligned along the rubbing direction of the oriented film, and are therefore set to a state of being twisted in the liquid crystal layer 214.

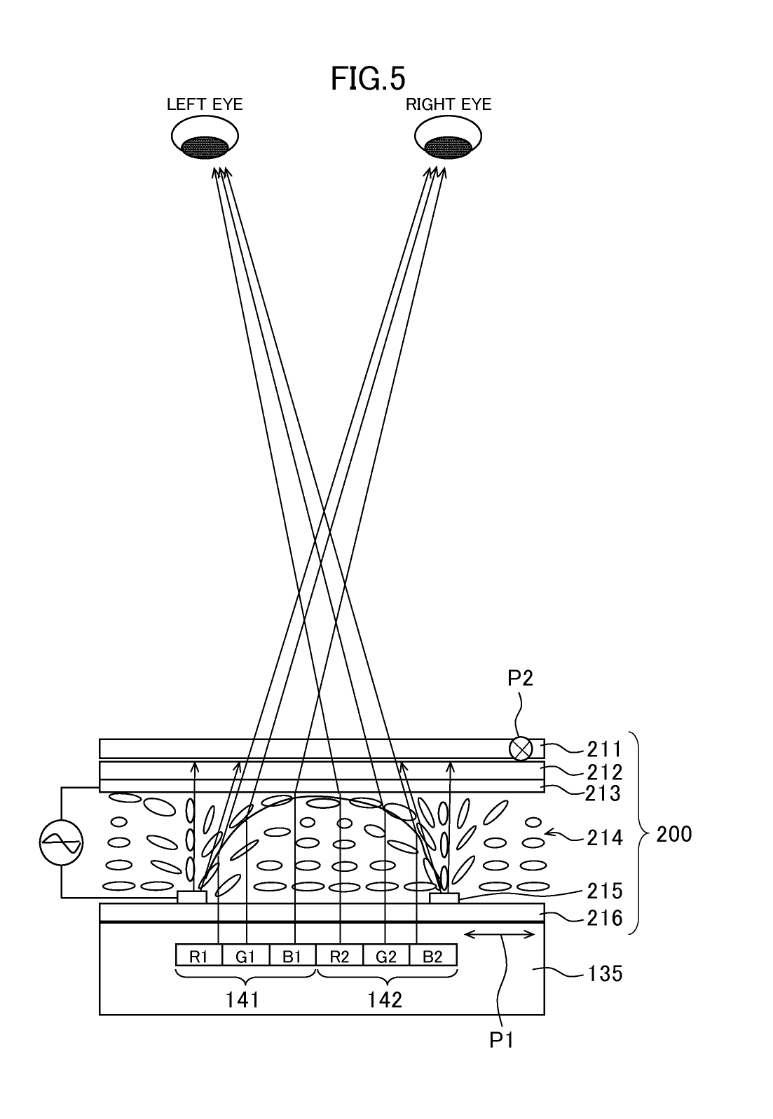

FIG. 5 is a diagram schematically showing traveling directions of light in the case of applying respective electrical potentials different from each other (an alternating-current voltage) to the sheet electrode 213 and each of the strip electrodes 215. Since the electrical potentials different from each other are applied, the liquid crystal lenses are formed in the liquid crystal layer 214, and the light emitted from the pixel 141 reaches the right eye, and the light emitted from the pixel 142 reaches the left eye. On this occasion, the liquid crystal above the strip electrode 215 provided to the glass substrate 216 on the near side to the liquid crystal display device 135 is oriented in the thickness direction of the liquid crystal layer 214, and therefore fails to exert the lens effect. Since no optical rotation occurs in the liquid crystal layer 214, it results that the light emitted from the liquid crystal display device 135 keeps the polarization state without modifications. The light transmitted through the vicinity of an area above the strip electrode 215 and keeping the polarization state is absorbed by the polarization plate 211, which has the polarization axis P2 perpendicular to the polarization direction P1 at the time point when the light is emitted from the liquid crystal display device 135.

Therefore, as described above, in the 3D display device according to the present embodiment, since the light transmitted through the vicinity of the area above the strip electrode 215 and causing the crosstalk can be blocked in the 3D display, clearer 3D display can be performed.

### Second Embodiment

A 3D display device capable of performing the vertical display (portrait) and the horizontal display (landscape) in a switching manner according to a second embodiment of the invention will be explained. Here, the configuration of the 3D display device according to the second embodiment is substantially the same as the configuration of the 3D display device according to the first embodiment shown in FIGS. 1 and 2, and redundant explanations will be omitted.

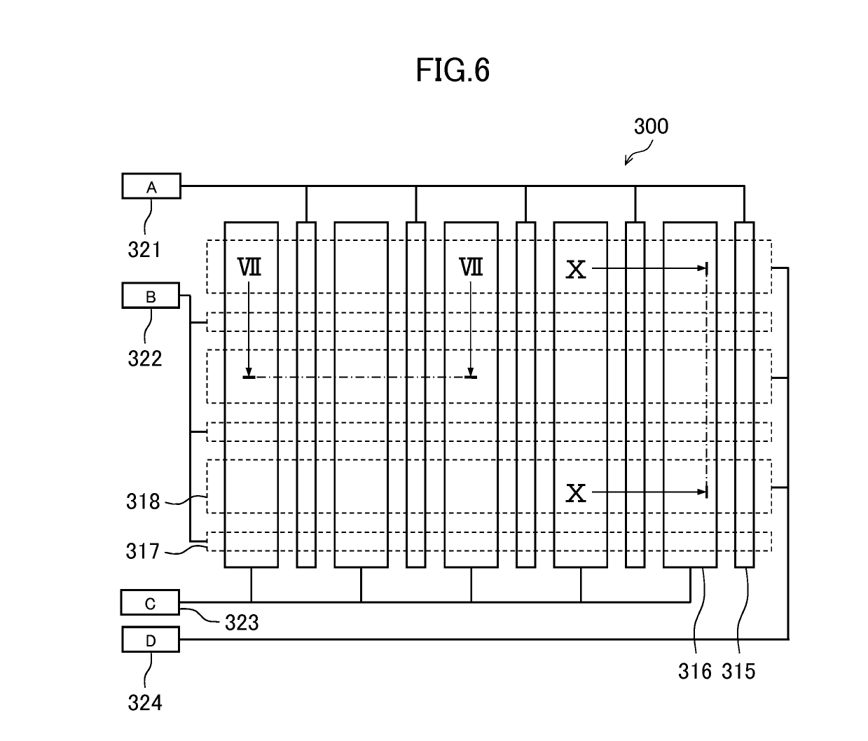

FIG. 6 is a plan view for explaining an arrangement of electrodes of a liquid crystal lens panel 300 capable of performing the vertical display and the horizontal display in a switching manner. As shown in this drawing, the liquid crystal lens panel 300 includes a plurality of strip electrodes 315 provided to a lower glass substrate 301 described later, plate electrodes 316 each formed between the strip electrodes 315 in the same layer as the strip electrodes 315, strip electrodes 317 provided to an upper glass substrate 302 described later, plate electrodes 318 each formed between the strip electrodes 317 in the same layer as the strip electrodes 317, a terminal 321 for applying an electrical potential to the strip electrodes 315, a terminal 323 for applying an electrical potential to the plate electrodes 316, a terminal 322 for applying an electrical potential to the strip electrodes 317, and a terminal 324 for applying an electrical potential to the plate electrodes 318.

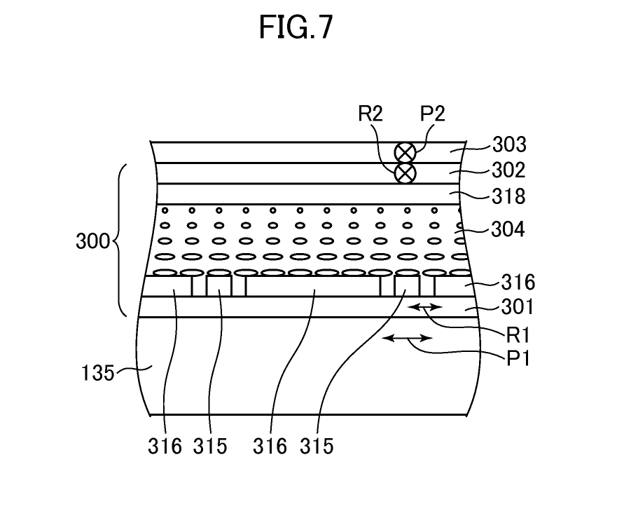

FIG. 7 is a diagram showing a cross-section along the VII-VII line shown in FIG. 6. As shown in this drawing, the liquid crystal lens panel 300 includes a liquid crystal layer 304 formed of the liquid crystal compositions varying the orientation in accordance with the electrical field, the lower glass substrate 301 as an insulating substrate disposed on the liquid crystal display device 135 side of the liquid crystal layer 304, and provided with the strip electrodes 315 and the plate electrodes 316, the upper glass substrate 302 as an insulating substrate disposed on the opposite side of the liquid crystal layer 304 to the liquid crystal display device 135 side, and provided with the strip electrodes 317 and the plate electrodes 318, and a polarization plate 303 disposed on the opposite side of the glass substrate 302 to the liquid crystal display device 135 side.

Here, P1 indicates a polarization direction of the light emitted from the liquid crystal display device 135, namely a polarization direction of an upper polarization plate of the liquid crystal display device 135, and R1 represents a rubbing direction of an oriented film formed on the lower glass substrate 301. As shown in the drawing, the polarization direction P1 and the rubbing direction R1 coincide with each other.

Further, P2 indicates a polarization direction of the polarization plate 303, and R2 represents a rubbing direction of an oriented film formed on the upper glass substrate 302. The polarization direction P2 and the rubbing direction R2 coincide with each other, and the direction thereof is perpendicular to the direction of the polarization direction P1 and the rubbing direction R1. In FIG. 7, the same electrical potential is applied to the strip electrodes 315, the plate electrodes 316, the strip electrodes 317, and the plate electrodes 318, and the liquid crystal compositions in the liquid crystal layer 304 are aligned along the rubbing direction of the oriented film, and are therefore set to the state of being twisted in the liquid crystal layer 304.

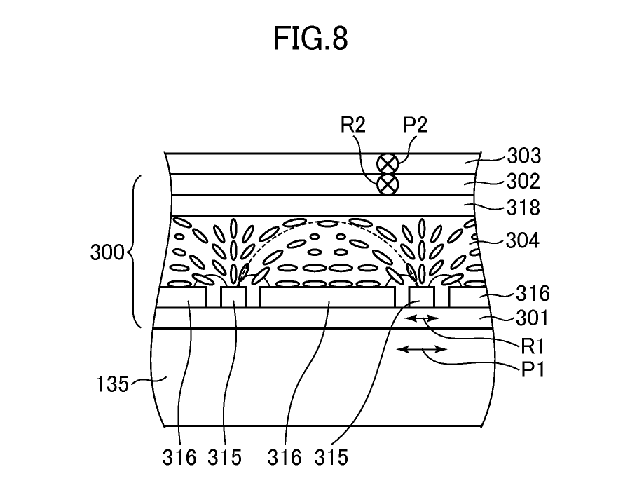

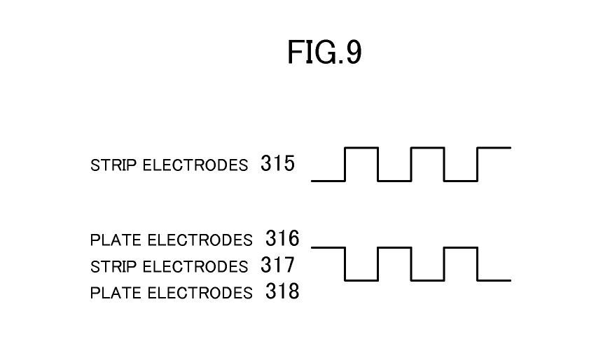

FIG. 8 is a diagram schematically showing the state of the orientation of the liquid crystal compositions in the case of performing the 3D display as the horizontal display in the same cross-section as in FIG. 7. In this case, electrical potentials different from each other (an alternating-current voltage) are applied respectively to the strip electrodes 315 and the other electrodes including the plate electrodes 316, the strip electrodes 317, and the plate electrodes 318. FIG. 9 shows a timing chart of the alternating-current voltage applied to the respective electrodes. As shown in these drawings, since the different electrical potential is applied only to the strip electrodes 315, the liquid crystal lenses are formed in the liquid crystal layer 304, and thus the 3D display can be performed as shown in FIG. 5 of the first embodiment. On this occasion, the liquid crystal in the vicinity of an area above the strip electrode 315 is oriented in the thickness direction of the liquid crystal layer 304, and therefore fails to exert the lens effect. Further, since no optical rotation occurs in the liquid crystal layer 304, it results that the light emitted from the liquid crystal display device 135 keeps the polarization state without modifications. The light having the polarization direction P1 transmitted through the vicinity of the area above the strip electrode 315 while keeping the polarization state is absorbed by the polarization plate 303 having the polarization axis direction P2 perpendicular to P1. Thus, the light transmitted through the vicinity of the area above the strip electrode 315 and causing the crosstalk can be blocked.

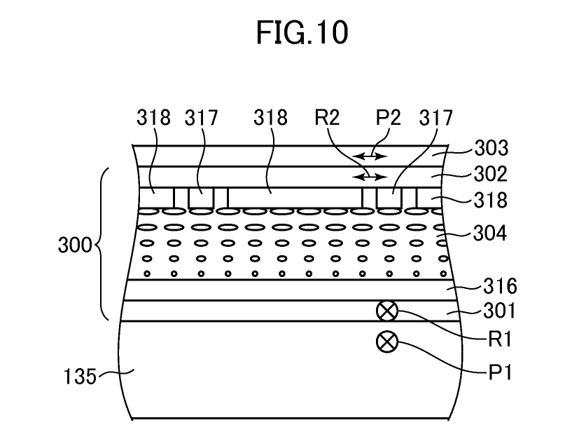

FIG. 10 is a diagram showing a cross-section along the X-X line shown in FIG. 6. In this drawing, the same electrical potential is applied to the strip electrodes 315, the plate electrodes 316, the strip electrodes 317, and the plate electrode 318, and the drawing is different from FIG. 7 only in the direction of the cross-section.

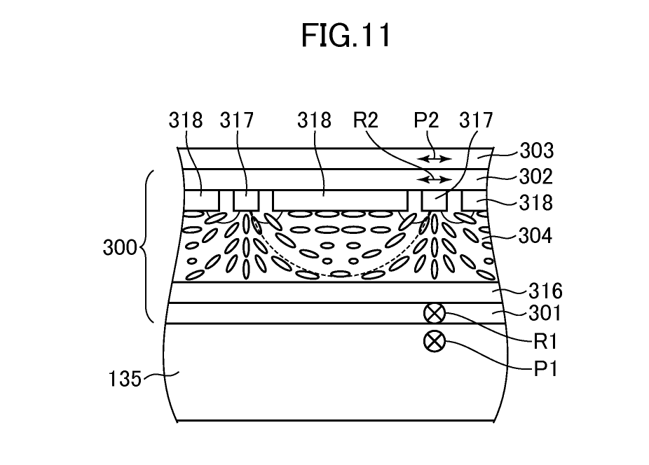

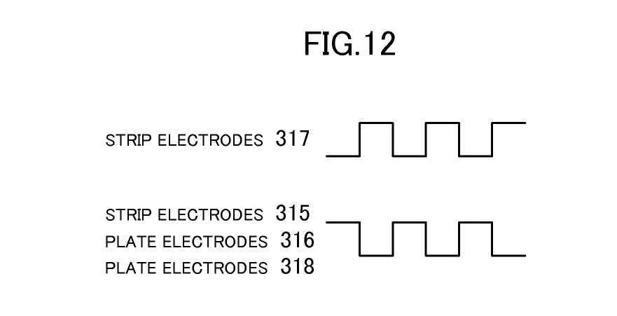

FIG. 11 is a diagram schematically showing the state of the orientation of the liquid crystal compositions in the case of performing the 3D display as the vertical display in the same cross-section as in FIG. 10. In this case, electrical potentials different from each other (an alternating-current voltage) are applied respectively to the strip electrodes 317 and the other electrodes including the strip electrodes 315, the plate electrodes 316, and the plate electrodes 318. FIG. 12 shows a timing chart of the alternating-current voltage applied to the respective electrodes. As shown in these drawings, since the different electrical potential is applied only to the strip electrodes 317, the liquid crystal lenses are formed in the liquid crystal layer 304, and thus the 3D display can be performed as shown in FIG. 5 of the first embodiment. On this occasion, the liquid crystal in the vicinity of an area above the strip electrode 317 is oriented in the thickness direction of the liquid crystal layer 304, and therefore fails to exert the lens effect. Further, since no optical rotation occurs in the liquid crystal layer 304, it results that the light emitted from the liquid crystal display device 135 keeps the polarization state without modifications. The light having the polarization direction P1 transmitted through the vicinity of the area above the strip electrode 317 while keeping the polarization state is absorbed by the polarization plate 303 having the polarization axis direction P2 perpendicular to P1. Thus, the light transmitted through the vicinity of the area above the strip electrode 317 and causing the crosstalk can be blocked.

Therefore, as described above, in the 3D display device according to the present embodiment, since the light transmitted through the vicinity of the area above the strip electrode 315 or the strip electrode 317 and causing the crosstalk can be blocked in the 3D display, clearer 3D display can be performed. While there have been described what are at present considered to be certain embodiments of the invention, it will be understood that various modifications may be made thereto, and it is intended that the appended claim cover all such modifications as fall within the true spirit and scope of the invention.

What is claimed is:

1. A display device comprising:
a display panel having a plurality of pixels arranged in a matrix, and adapted to display an image;
a liquid crystal lens panel disposed on the display panel, and adapted to form a lenticular lens by switching; and
a polarization plate disposed on an opposite side of the liquid crystal lens panel to the display panel,
wherein the liquid crystal lens panel includes
a liquid crystal layer having liquid crystal compositions,
a first insulating substrate disposed on the display panel side of the liquid crystal layer,
a second insulating substrate disposed on the polarization plate side of the liquid crystal layer, and having an oriented film with a rubbing direction perpendicular to a rubbing direction of an oriented film of the first insulating substrate, and
a plurality of strip electrodes each formed of a strip-shaped electrically-conductive film extending in one direction, arranged side by side on either one of the first insulating substrate and the second insulating substrate, wherein
a polarization axis direction of the polarization plate is the same as the rubbing direction of the oriented film of the second insulating substrate.

2. The display device according to claim 1, further comprising:
a sheet electrode, which is an electrically-conductive film formed evenly throughout an entire display area on the other of the first insulating substrate and the second insulating substrate.

3. The display device according to claim 1,
the strip electrodes corresponding to first strip electrodes formed on the first insulating substrate, further comprising:
a plurality of second strip electrodes each formed of a strip-shaped electrically-conductive film extending in a direction perpendicular to the one direction, arranged side by side on the second insulating substrate.

4. The display device according to claim 1, wherein
the strip electrodes adjacent to each other are arranged side by side with an interval corresponding to two pixels.
